(19) United States
(12) Patent Application Publication
(10) Pub. No.: US 2017/0337087 A1
(43) Pub. Date: Nov. 23, 2017

(54) SYSTEM AND METHODOLOGY FOR IMPLEMENTING THE SAFE DE-PROVISIONING OF POOLED CLOUD RESOURCES

(71) Applicant: Knight Point Systems, Inc., Reston, VA (US)

(72) Inventors: Roy Keene, Reston, VA (US); Kenneth Van Alstyne, Reston, VA (US)

(21) Appl. No.: 15/493,228

(22) Filed: Apr. 21, 2017

Related U.S. Application Data
(60) Provisional application No. 62/326,095, filed on Apr. 22, 2016.

(51) Int. Cl. G06F 9/50; G06F 11/34; H04L 12/917; G06F 9/455; H04L 12/911

(52) U.S. Cl. CPC G06F 9/5022; G06F 11/3466; H04L 47/76; G06F 9/5077; H04L 47/783; G06F 2009/4557

(57) ABSTRACT

A system and method of implementing safe deprovisioning of pooled cloud resources in response to physical resource shut down, comprises a cluster of computer system devices. At least one memory device among the one or more memory devices stores a set of program modules, and an Advanced Configuration and Power Interface (ACPI) open-standard specification. A set of program modules comprises an input module, a shutdown module, and a data transfer module. The input module receives from a first computer system device among the cluster, a first signal. The first signal comprises information regarding a power-off event triggered in the first computer system device. The data transfer module implements the ACPI open-standard specification in the first computer system device, and migrate data comprised in the first computer system device into a second computer system device. The shutdown module to de-power the first computer system device.

### CROSS REFERENCE TO APPLICATION

This patent application claims the benefit of U.S. Provisional Application No. 62/326,095 filed on Apr. 22, 2016. The above application is incorporated by reference herein in its entirety.

### FIELD OF THE INVENTION

The present invention relates generally to a system and method for implementing the safe deprovisioning of pooled physical resources in response to a shutdown of the physical resources in the cloud, and, more particularly, to a system and method for ensuring the communication and safe transfer and/or migration of workloads and/or data as between different nodes in the cloud upon shut-down and/or physical de-provisioning of one or more of those nodes.

### BACKGROUND OF THE INVENTION

Cluster of computer systems refer to a group of computing devices interconnected via a communications network. As such, cluster computer systems act effectively as a single system with each computer system of the cluster of computer systems assigned tasks, which are scheduled by a software. Cluster computer systems are autonomous systems, but they need to all act together to achieve a common unified goal. Typically, specific goals and configuration items are stored in one of the computer systems and the autonomous computer systems reconfigure themselves accordingly.

Each of the computer systems of the cluster is provisioned as at least one of a compute node and a storage node. Upon physical shutdown of a computer system in the cluster, it is necessary to de-provision the computer system and an associated node. Upon a user pressing a shutdown button, computer system devices in the cluster will naturally power off without transferring workloads to other computer systems in the cluster. In a clustered configuration where workloads must persist past the existence of a single node, nodes must communicate across one another to ensure workloads are migrated to other nodes before shutdown of one can occur.

Hence, there is a need for a system and method of implementing safe deprovisioning of pooled cloud resources in response to physical resource shut down.

### SUMMARY OF THE INVENTION

In order to address such need, and upon detection that an administrator has physically pressed a power button on a computer system device in a cluster, (i.e., a power-off event is beginning), an Advanced Configuration and Power Interface (ACPI) open-standard specification is implemented by a CLOUDSEED™ software. Depending on type of node functioning in the computer system device, the CLOUDSEED™ software immediately begins a de-provisioning process. The node is one of a compute node and a storage node. In the case the node is a storage node, individual storage units in the storage node are marked as “down” and data will automatically begin migrating off of the storage node. Once data migration is complete, the storage units in the storage nodes are all marked as “out” and then are removed from at least one storage cluster configuration. Upon completion, the node is physically powered off and is ready to be repurposed or unbracketing the case of a compute node, a set of virtual machines running in the compute node are live migrated (if possible—if not, any other migration method will be used, disruptively) to another compute node in the cluster. Once no virtual machines are running on that compute node, the compute node is removed from the computer cluster and the node is physically powered off and is ready to be repurposed or unracked.

The present invention relates to a system and method of implementing safe deprovisioning of pooled cloud resources in response to physical resource shut down.

In one embodiment of the present invention, a system for implementing safe deprovisioning of pooled cloud resources in response to physical resource shut down, comprises a cluster of computer system devices. Further, the system comprises one or more memory devices, comprised in one or more computer system devices of the cluster of computer system devices. At least one memory device among the one or more memory devices stores a set of program modules, and an Advanced Configuration and Power Interface (ACPI) open-standard specification. The system further comprises a plurality of processors, each processor being comprised in each computer system device of the cluster of computer system devices. At least one processor executes the set of program modules. The set of program modules comprises an input module, a data transfer module, and a shutdown module. The input module, executed by the at least one processor, receives from a first computer system device among the cluster, a first signal. The first signal comprises information regarding a power-off event triggered in the first computer system device. The data transfer module, implements the ACPI open-standard specification in the first computer system device, and migrates data comprised in the first computer system device into a second computer system device among the cluster of computer system devices. The shutdown module, executed by the at least one processor, configured to de-power the first computer system device.

In one embodiment, the power-off event is triggered by at least one of a user pressing at least one power button comprised in the first computer system device. Further, computer system devices in the cluster are interconnected via at least one of a local area network, a wireless local area network, a Bluetooth network, a WI-FI network, and a mobile network. Moreover, the computer system devices in the cluster are at least one of a compute node and a storage node. The data transfer module live migrates one or more virtual machines running in the first computer system device to the second computer system device, based on the first computer system device being the computer node. Each computer system device in the cluster of computer system device is at least one of a laptop, a server, a local area network, a personal computer, and a smart phone, or any combination thereof. The computer system devices in the cluster incorporates Operating System-directed Power Management (OSPM) with direct and exclusive control over power management, from the ACPI open-standard specification.

In one embodiment of the present invention, a method of implementing safe deprovisioning of pooled cloud resources in response to physical resource shut down comprises storing in at least one memory device, a set of program modules, and an Advanced Configuration and Power Interface (ACPI) open-standard specification. Further, the method comprises receiving by at least one processor via an input module, a first signal from a first computer system device. The first signal comprises information regarding a power-off event triggered in the first computer system device. Furthermore, the method comprises implementing by the at least one processor via a data transfer module, the ACPI open-standard specification in the computer system device. Moreover, the method comprises migrating by the at least one processor via the data transfer module, data comprised in the first computer system device into a second computer system device among the cluster of computer system devices. Moreover, the method comprises de-powering by the at least one processor via a shutdown module, the first computer system device.

### BRIEF DESCRIPTION OF DRAWINGS

FIG. 1 is a block diagram of an environment implemented in accordance with various embodiments of the invention.

FIG. 2 is a block diagram of a system for implementing safe deprovisioning of pooled cloud resources in response to physical resource shut down in accordance with various embodiments of the invention.

FIG. 3 is a flowchart of a computer implemented method of implementing safe deprovisioning of pooled cloud resources in response to physical resource shut down in accordance with various embodiments of the invention.

### DETAILED DESCRIPTION OF EMBODIMENTS

The present invention teaches a system and method by which the communication and safe transfer and/or migration of workloads and/or data as between different nodes in the cloud upon shut-down and/or physical de-provisioning of one or more of those nodes is ensured.

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

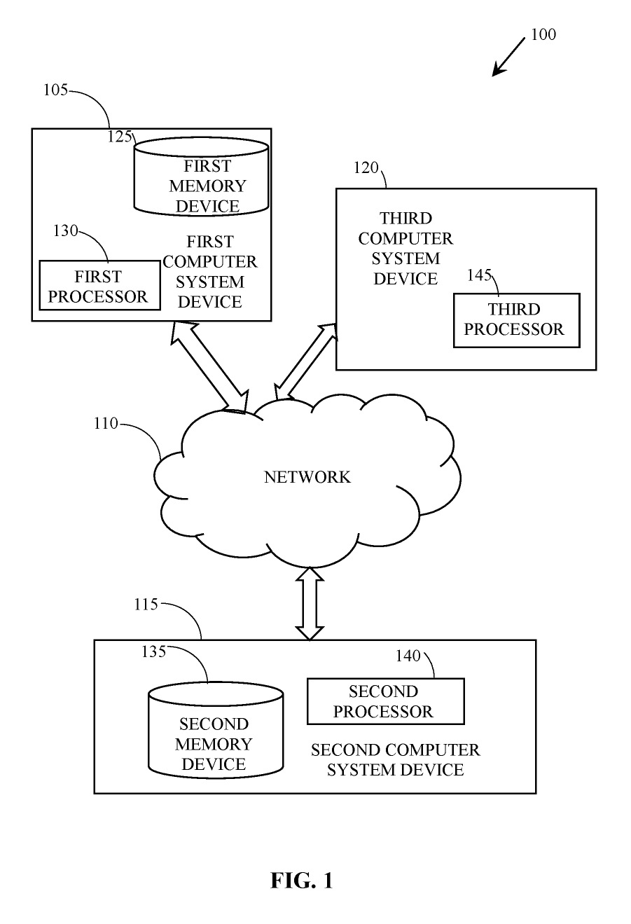

FIG. 1 is a block diagram of an environment 100 in accordance with which various embodiments of the present invention are implemented. The environment 100 comprises a first computer system device 105, a second computer system device 115, and a third computer system device 120. In one example, the first computer system device 105, the second computer system device 115, and the third computer system device 120 are connected as a computer cluster. In one example, the computer cluster use one of Trivial File Transfer Protocol (TFTP), and Dynamic Host Configuration Protocol (DHCP) to communicate with each other. The cluster of computers is enabled to host a floating Pre-boot Execution Environment. The first computer system device 105, the second computer system device 115, and the third computer system device 120 are at least one of a laptop, a personal computer, a server, a smart phone, and a smart television. In another example, the first computer system device 105, the second computer system device 115, and the third computer system device 120 are gateways to at least one of a wide area network, a local area network, and internet. The first computer system device 105, the second computer system device 115, and the third computer system device 120 are connected via a network 110. The network 110 is at least one of a mobile network, a WIFI network, a Wireless Local area network, a Bluetooth network, a wide area network, a local area network, and internet. The first computer system device 105 comprises a first memory device 125 and a first processor 130. The second computer system device 115 comprises a second memory device 135, and a second processor 140. The third computer system device 120 comprises a third processor 145.

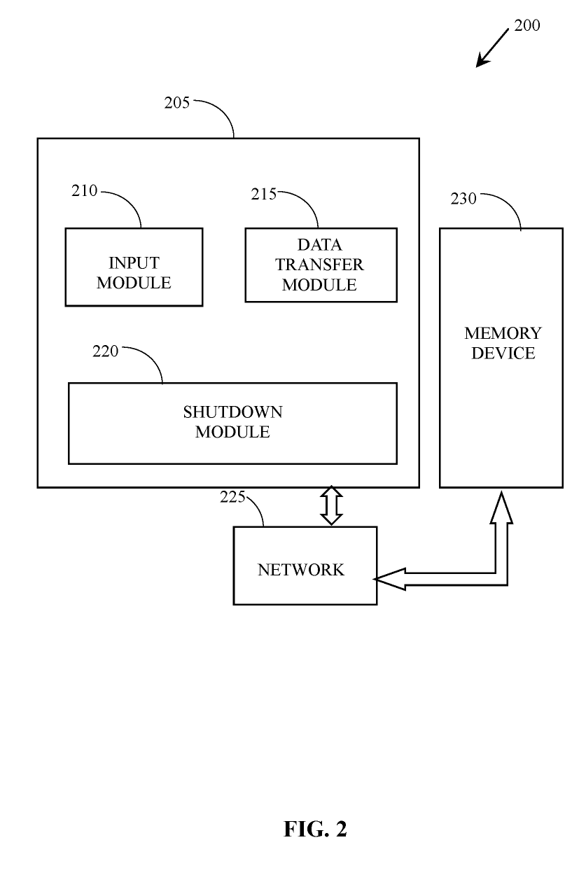

At least one of the first memory device 125 and the second memory device 135 is a designated data staging area. Further, at least one of the first memory device 125 and the second memory device 135 stores a set of program modules. At least one processor among the first processor 130, the second processor 140, and the third processor 145 executes the set of program modules. In one example, the set of program modules are executed by a combination of multiple processors among the first processor 130, the second processor 140, and the third processor 145. FIG. 2 is a block diagram of a system 200 for implementing safe deprovisioning of pooled cloud resources in response to physical resource shut down according to one example of functioning of the present invention.

In one embodiment of the present invention, a memory device 230 stores a set of program modules, and an Advanced Configuration and Power Interface (ACPI) open-standard specification. The set of program modules comprises an input module 210, a data transfer module 215, and a shutdown module 220. The system 200 further comprises a processor 205 to execute the set of program modules.

The input module 210, executed by the processor 205, receives from a first computer system device among a cluster of computer system devices, a first signal. Computer system devices in the cluster are interconnected via network 225. The network 225 is at least one of a local area network, a wireless local area network, a Bluetooth network, a WI-FI network, and a mobile network. Each computer system device in the cluster of computer system device is at least one of a laptop, a server, a local area network, a personal computer, and a smart phone, or any combination thereof. The computer system devices in the cluster incorporates Operating System-directed Power Management (OSPM) with direct and exclusive control over power management, from the ACPI open-standard specification. The first signal comprises information regarding a power-off event triggered in the first computer system device.

In one embodiment, the power-off event is triggered by at least one of a user pressing at least one power button comprised in the first computer system device. In another example, the power-off event is triggered automatically by the first computer system device.

The data transfer module 215, implements the ACPI open-standard specification in a first computer system device, and migrates data comprised in the first computer system device into a second computer system device among the cluster of computer system devices.

In one example, computer system devices in the cluster are at least one of a compute node and a storage node. The data transfer module 215 live migrates one or more virtual machines running in the first computer system device to the second computer system device, based on the first computer system device being the computer node. The shutdown module 220, is configured to de-power the first computer system device, thereby implementing safe deprovisioning of pooled cloud resources in the cluster of computer system devices, in response to physical resource shut down.

In one embodiment of the present invention, a CLOUDSEED™ software performs a de-provisioning process on the first computer system device. If the first computer system device is a storage node, then individual storage units in the storage node are marked as “down” by the system 200 and data will automatically begin migrating off of the storage node. Once data migration is complete, the storage units in the storage nodes are all marked as “out” by the system 200 and then are removed from the cluster. Upon removal, the first computer system device is physically powered off and is ready to be repurposed or untracked the first computer system device is a compute node, a plurality of virtual machines running using resources of the first computer system device are live migrated to another compute node in the cluster. Once no virtual machines are running using resources of the first computer system device, the compute node is removed from the computer cluster and the node is physically powered off and is ready to be repurposed or unracked. In either node type, the system 200 will only de-power the node after de-provisioning is completely successful.

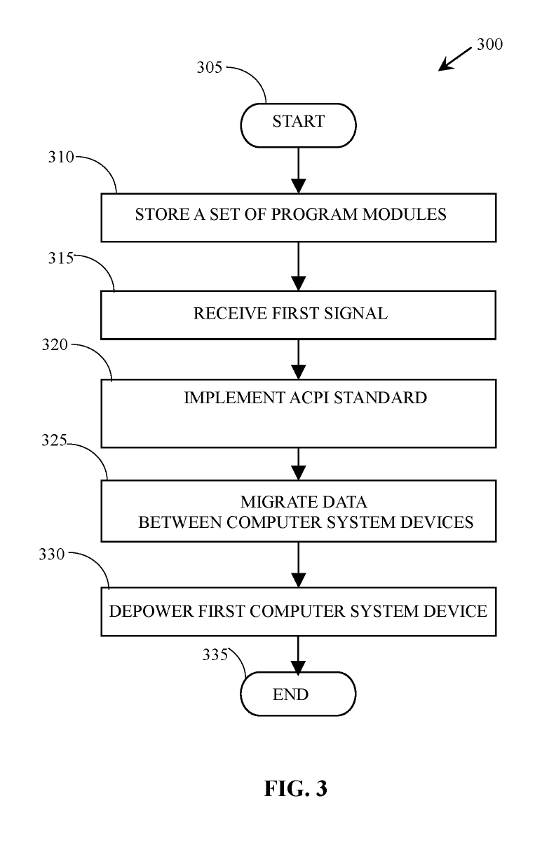

FIG. 3 is a flowchart of a method 300 implementing safe deprovisioning of pooled cloud resources in response to physical resource shut down in accordance with which various embodiments of the present invention are implemented. The method 300 allows for migration of data and/or workloads as between differing nodes on a computer cluster. The method 300 allows for replacement and/or repair of particular nodes without hampering or diminishing the capability of the cluster. The method 300 is comprised in an environment comprising at least one of a first computer system device, a second computer system device, and a third computer system device. In one example, the first computer system device, the second computer system device, and the third computer system device are connected as a computer cluster. In one example, the computer cluster use one of Trivial File Transfer Protocol (TFTP), and Dynamic Host Configuration Protocol (DHCP) to communicate with each other. The cluster of computers is enabled to host a floating Pre-boot Execution Environment. The first computer system device, the second computer system device, and the third computer system device are at least one of a laptop, a personal computer, a server, a smart phone, and a smart television. In another example, the first computer system device, the second computer system device, and the third computer system device are gateways to at least one of a wide area network, a local area network, and internet. The first computer system device, the second computer system device, and the third computer system device are connected via a network. The network is at least one of a mobile network, a wide area network, a local area network, and internet. The first computer system device comprises a first memory device and a first processor. The second computer system device comprises a second memory device, and a second processor. The third computer system device comprises a third processor.

At least one of the first memory device and the second memory device stores a set of program modules. At least one processor among the first processor, the second processor, and the third processor executes the set of program modules. In one example, the set of program modules are executed by a combination of multiple processors among the first processor, the second processor, and the third processor. The method 300 commences at step 305.

At step 310, a memory device stores a set of program modules, and an Advanced Configuration and Power Interface (ACPI) open-standard specification. The set of program modules comprises an input module, a data transfer module, and a shutdown module. The system further comprises a processor to execute the set of program modules.

At step 315, the input module, executed by the processor, receives from a first computer system device among a cluster of computer system devices, a first signal. The first signal comprises information regarding a power-off event triggered in the first computer system device. In one example, the power-off event is triggered by at least one of a user pressing at least one power button comprised in the first computer system device. In another example, the power-off event is triggered automatically by the first computer system device. It is noted that computer system devices in the cluster are interconnected via at least one of a local area network, a wireless local area network, a Bluetooth network, a WI-FI network, and a mobile network. Each computer system device in the cluster of computer system device is at least one of a laptop, a server, a local area network, a personal computer, and a smart phone, or any combination thereof. The computer system devices in the cluster incorporates Operating System-directed Power Management (OSPM) with direct and exclusive control over power management, from the ACPI open-standard specification. It is to be understood, however, that other power management specifications and/or methodologies may be utilized in powering down of nodes, servers and/or other devices in the computer cluster.

At step 320, the data transfer module, implements the ACPI open-standard specification in a first computer system device.

At step 325, the data transfer module, migrates data comprised in the first computer system device into a second computer system device among the cluster of computer system devices. In one example, computer system devices in the cluster are at least one of a compute node and a storage node. The data transfer module live migrates one or more virtual machines running in the first computer system device to the second computer system device, based on the first computer system device being the compute node.

At step 330, the shutdown module, de-powers the first computer system devices, thereby implementing safe deprovisioning of pooled cloud resources in the computer cluster in response to physical resource shut down.

The method 300 ends at step 335.

In one embodiment of the present invention, a CLOUDSEED™ software preforms a de-provisioning process on the first computer system device. If the first computer system device is a storage node, then individual storage units in the storage node are marked as “down” by the system and data will automatically begin migrating off of the storage node. Once data migration is complete, the storage units in the storage nodes are all marked as “out” by the system and then are removed from the cluster. Upon removal, the first computer system device is physically powered off and is ready to be repurposed or unracked. If the first computer system device is a compute node, a plurality of virtual machines running using resources of the first computer system device are live migrated to another compute node in the cluster. Once no virtual machines are running using resources of the first computer system device, the compute node is removed from the computer cluster and the node is physically powered off and is ready to be repurposed or unracked. In either node type, the system will only de-power the node after de-provisioning is completely successful.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for implementing safe deprovisioning of pooled cloud resources in response to physical resource shut down, the system comprising:
a cluster of computer system devices;
one or more memory devices, comprised in one or more computer system devices of the cluster of computer system devices, wherein at least one memory device among the one or more memory devices stores a set of program modules, and an Advanced Configuration and Power Interface (ACPI) open-standard specification;
a plurality of processors, each processor being comprised in each computer system device of the cluster of computer system devices, wherein at least one processor executes the set of program modules, the set of program modules comprising:
an input module, executed by the at least one processor, configured to receive from a first computer system device among the cluster, a first signal, wherein the first signal comprises information regarding a power-off event triggered in the first computer system device;
a data transfer module, executed by the at least one processor, configured to
implement the ACPI open-standard specification in the first computer system device, and
migrate data comprised in the first computer system device into a second computer system device among the cluster of computer system devices; and
a shutdown module, executed by the at least one processor, configured to de-power the first computer system device, thereby implementing safe deprovisioning of pooled cloud resources in the cluster of computer system devices, in response to physical resource shut down.

2. The system of claim 1, wherein the power-off event is triggered by at least one of a user pressing at least one power button comprised in the first computer system device.

3. The system of claim 1, wherein computer system devices in the cluster are interconnected via at least one of a local area network, a wireless local area network, a Bluetooth network, a WI-FI network, and a mobile network.

4. The system of claim 1, wherein the computer system devices in the cluster are at least one of a compute node and a storage node.

5. The system of claim 4, wherein the data transfer module live migrates one or more virtual machines running in the first computer system device to the second computer system device, based on the first computer system device being the computer node.

6. The system of claim 1, wherein each computer system device in the cluster of computer system device is at least one of a laptop, a server, a local area network, a personal computer, and a smart phone, or any combination thereof.

7. The system of claim 1, wherein the computer system devices in the cluster incorporates Operating System-directed Power Management (OSPM) with direct and exclusive control over power management, from the ACPI open-standard specification.

8. A method of implementing safe deprovisioning of pooled cloud resources in response to physical resource shut down, the method comprising:
storing in at least one memory device, a set of program modules, and an Advanced Configuration and Power Interface (ACPI) open-standard specification;
receiving by at least one processor via an input module, a first signal from a first computer system device, wherein the first signal comprises information regarding a power-off event triggered in the first computer system device;
implementing by the at least one processor via a data transfer module, the ACPI open-standard specification in the computer system device;
migrating by the at least one processor via the data transfer module, data comprised in the first computer system device into a second computer system device among the cluster of computer system devices; and
de-powering by the at least one processor via a shutdown module, the first computer system device thereby implementing safe deprovisioning of pooled cloud resources in the cluster of computer system devices, in response to physical resource shut down.

9. The method of claim 8, wherein the power-off event is triggered by at least one of a user pressing at least one power button comprised in the first computer system device.

10. The method of claim 8, wherein computer system devices in the cluster are interconnected via at least one of a local area network, a wireless local area network, a Bluetooth network, a WI-FI network, and a mobile network.

11. The method of claim 8, wherein the computer system devices in the cluster are at least one of a compute node and a storage node.

12. The method of claim 11, wherein the data transfer module live migrates one or more virtual machines running in the first computer system device to the second computer system device, based on the first computer system device being the compute node.

13. The method of claim 8, wherein each computer system device in the cluster of computer system device is at least one of a laptop, a server, a local area network, a personal computer, and a smart phone, or any combination thereof.

14. The method of claim 8, wherein the computer system devices in the cluster incorporates Operating System-directed Power Management (OSPM) with direct and exclusive control over power management, from the ACPI open-standard specification.
